(19) United States
(12) Patent Application Publication
(10) Pub. No.: US 2019/0141560 A1
(43) Pub. Date: May 9, 2019

(54) CALL ADMISSION CONTROL FOR MULTIMEDIA DELIVERY IN MULTI-RADIO ACCESS TECHNOLOGY NETWORKS

(71) Applicant: Nokia Solutions and Networks OY, Espoo (FI)

(72) Inventors: Kamakshi SRIDHAR, Plano, TX (US); Francis DOMINIQUE, Sunnyvale, CA (US); Mohammad Riaz KHAWER, Lake Hopatcong, NJ (US)

(73) Assignee: Nokia Solutions and Networks OY, Espoo (FI)

(21) Appl. No.: 15/805,613

(22) Filed: Nov. 7, 2017

(51) Int. Cl. H04W 28/02; H04L 12/707; H04L 12/721; H04L 12/803; H04L 12/801

(52) U.S. Cl. CPC H04W 28/0205; H04L 45/24; H04W 88/14; H04L 47/125; H04L 47/14; H04L 45/38

(57) ABSTRACT

A radio access network element includes a memory and at least one processor coupled to the memory. The memory stores computer-readable instructions. The at least one the at least one processor configured to execute the computer-readable instructions to: estimate, for a multimedia flow for a user equipment, a throughput for each of a plurality of different air interfaces, the throughput for a respective air interface among the plurality of different air interfaces including (i) an amount of available bandwidth on the respective air interface and (ii) an amount of available bandwidth on a backhaul link associated with the respective air interface; select an air interface from among the plurality of different air interfaces based on the throughput for each of the plurality of different air interfaces; and admit the multimedia flow on the selected air interface.

### BACKGROUND

### Field

One or more example embodiments relate to methods, apparatuses or computer-readable storage mediums for call admission control for delivery of multimedia flows in multi-connectivity networks.

### Discussion of Related Art

One driver of growth in demand for mobile wireless data is streaming multimedia, such as video. In one example, streaming video is delivered through Hyper-Text-Transfer-Protocol (HTTP) Adaptive Streaming (HAS).

### SUMMARY

One or more example embodiments relate to methods, apparatuses or computer-readable storage mediums for call admission control for delivery of multimedia flows in multi-connectivity networks.

At least one example embodiment provides a radio access network element comprising: a memory storing computer-readable instructions; and at least one processor coupled to the memory. The at least one processor is configured to execute the computer-readable instructions to: estimate, for a multimedia flow for a user equipment, an amount of available bandwidth on a first of a plurality of different air interfaces and an amount of available bandwidth on a first backhaul link associated with the first of the plurality of different air interfaces; and admit the multimedia flow on the first of the plurality of different air interfaces if the amount of available bandwidth on the first of the plurality of different air interfaces and the amount of available bandwidth on the first backhaul link are greater than or equal to a maximum encoding rate for the multimedia flow.

At least one other example embodiment provides a radio access network element comprising: a memory storing computer-readable instructions; and at least one processor coupled to the memory. The at least one processor is configured to execute the computer-readable instructions to: estimate, for a multimedia flow for a user equipment, a throughput for each of a plurality of different air interfaces, the throughput for a respective air interface among the plurality of different air interfaces including (i) an amount of available bandwidth on the respective air interface and (ii) an amount of available bandwidth on a backhaul link associated with the respective air interface; select an air interface from among the plurality of different air interfaces based on the throughput for each of the plurality of different air interfaces; and admit the multimedia flow on the selected air interface.

At least one other example embodiment provides a method for call admission control in a multi-connectivity network, the method comprising: estimating, for a multimedia flow for a user equipment, a throughput for each of a plurality of different air interfaces, the throughput for a respective air interface among the plurality of different air interfaces including (i) an amount of available bandwidth on the respective air interface and (ii) an amount of available bandwidth on a backhaul link associated with the respective air interface; selecting an air interface from among the plurality of different air interfaces based on the throughput for each of the plurality of different air interfaces; and admitting the multimedia flow on the selected air interface.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 illustrates a network architecture diagram including a CloudRAN server according to an example embodiment.

FIG. 2 is a flow chart illustrating a method for call admission control according to an example embodiment.

FIG. 3 provides a general architecture and functionality suitable for implementing functional elements described herein or portions of functional elements described herein.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, the specific structural and functional details are merely representative for the purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Example embodiments will be primarily discussed herein with regard to multimedia flows, such as video and audio, which may be delivered to user equipment (UEs) via Hyper-Text-Transfer-Protocol (HTTP) Adaptive Streaming (HAS). However, example embodiments may be applicable to other application services such as Voice over Internet Protocol (VoIP), web browsing, instant messaging, email download, software download or any other IP-based service delivered to a mobile or other device using 3rd Generation Partnership Project (3GPP) and/or wireless local area network (WLAN) access. Further, a multimedia flow may also be referred to as a requested flow, a multimedia application or a multimedia stream.

To ensure sufficient Quality of Service (QoS) and hence Quality of Experience (QoE) for a multimedia flow, a suitable encoding rate (sometimes referred to herein as a data rate) needs to be delivered to a UE.

One or more example embodiments provide call admission control (CAC) in a multi-connectivity network (e.g., a heterogeneous network (HetNet) including a plurality of different radio access technologies (RATs)) to ensure that a threshold QoS/QoE for a given multimedia flow for a UE is met when the multimedia flow is admitted into a serving cell or network. In one example, the multi-connectivity network may include a plurality of different radio interfaces, such as 3rd Generation (3G), 4th Generation (4G) and 5th Generation (5G) interfaces, WLAN standalone hotspots such as Wi-Fi hotspots, and the like, across both the licensed and unlicensed spectra, as well as across macro cells, metro cells and femto cells. According to at least one example embodiment, bandwidth resources needed at both the air interface and the associated backhaul link (whether wired or wireless) are taken into account, and the appropriate channel to support the encoding rate needed to achieve the desired QoS/QoE for the multimedia flow may be selected at the time the multimedia flow is admitted.

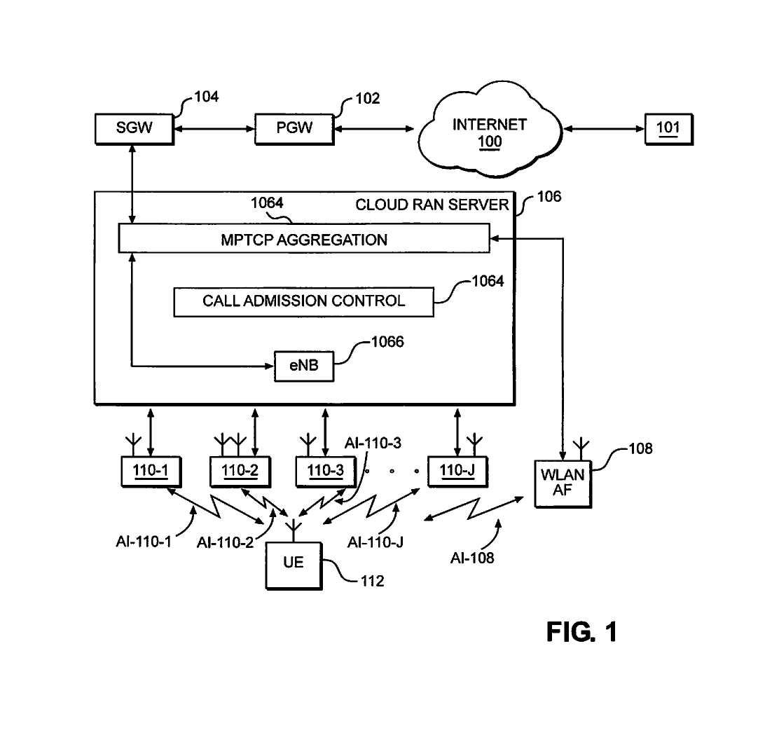

FIG. 1 illustrates a network architecture including a CloudRAN server 106 according to an example embodiment.

Referring to FIG. 1, the CloudRAN server 106 is a hardware computing platform, which may be built around multiple server boards utilizing processing circuitry, such as one or more processors. The hardware computing platform may run various applications in, for example, a virtualized fashion; however, virtualization is not required. The CloudRAN server 106 may be located at a central office (CO), and may serve multiple cellular radio sites (e.g., radio units 110_1, 110_2, 110_3, . . . , 110_J discussed in more detail later), which operate according to one or more different RATs. The CloudRAN server 106 may also be referred to as a radio access network element.

In the example embodiment shown in FIG. 1, the CloudRAN server 106 includes a Multipath Transmission Control Protocol (MPTCP) aggregation layer 1062 (also referred to herein as MPTCP aggregation 1062), call admission control 1064 (also referred to herein as call admission controller 1064), and eNB 1066, each of which may be hosted or run as virtualized applications. Although not specifically shown in FIG. 1, the CloudRAN server 106 may also host or run other applications, such as Operations Administration and Maintenance (OAM), Transport, edge services, or the like.

The MPTCP aggregation layer 1062 may be implemented as a MPTCP proxy server at the CloudRAN server 106. In one example, the MPTCP aggregation layer 1062 is logically situated above the Packet Data Convergence Protocol (PDCP) layer of the 3GPP 4G/5G protocol stack. In this example, the term proxy is used to denote that the MPTCP aggregation layer sits in the mobile operator's network.

According to at least one example embodiment, at the network side, the MPTCP aggregation layer 1062 communicates with one or more application servers 101 via a backhaul link. In this example, the backhaul link traverses at least portions of the Evolved Packet Core (e.g., a serving gateway (SGW) 104 and a packet data network gateway (PGW) 102) and the Internet 100. However, example embodiments should not be limited to this example. Further, although only a single application server 101 is shown in FIG. 1, example embodiments should not be limited to this example.

The MPTCP aggregation layer 1062 utilizes MPTCP, which enables multiple different air interfaces to be aggregated in various combinations (specified, e.g., in Internet Engineering Task Force (IETF) RFC 6824). This aggregation allows one Transmission Control Protocol (TCP) flow from the application server 101 to be delivered to a UE (e.g., UE 112) over multiple paths to increase throughput and encoding rates in, for example, a multi-connectivity radio access network (RAN). In one example, MPTCP allows for aggregation of a plurality of different radio interfaces (e.g., 3G, 4G, 5G, WLAN standalone hotspots such as Wi-Fi hotspots, and the like) across both the licensed and unlicensed spectra, as well as across macro cells, metro cells and femto cells, thereby allowing traffic to be simultaneously or concurrently routed over a plurality of different radio interfaces depending on congestion levels, type of application flow, UE mobility, and the like.

Still referring to FIG. 1, in one example, the MPTCP aggregation layer 1062 intercepts and terminates an incoming TCP flow from the application server 101 on the backhaul link, and sends acknowledgement ACK messages back to the application server 101. The MPTCP aggregation layer 1062 selects appropriate air interfaces, and opens separate MPTCP connections towards the destination MPTCP client (e.g., at a UE such as UE 112) such that the incoming TCP flow may be provided to the destination MPTCP client across the appropriate air interfaces simultaneously or concurrently.

The MPTCP aggregation layer 1062 supports air interface discovery, and utilizes a state machine to track available air interfaces, as well as the radio conditions for the available air interfaces. The MPTCP aggregation layer 1062 assigns a multimedia flow for a UE to one or more air interfaces to optimize QoS/QoE for UEs based on an internal load balancing engine. MPTCP utilizes its own TCP congestion control mechanism to load balance traffic across multiple air interfaces based on congestion. In one example, the MPTCP aggregation layer 1062 examines round trip times of TCP ACKs, infers congestion levels based on the delay of the packets, and determines an air interface to which a packet should be sent based on the congestion levels.

To recover the traffic sent across multiple air interfaces, the destination MPTCP client receives packets over the multiple air interfaces via MPTCP, reassembles the received packets in the correct order and detects lost packets for which retransmission is to be requested.

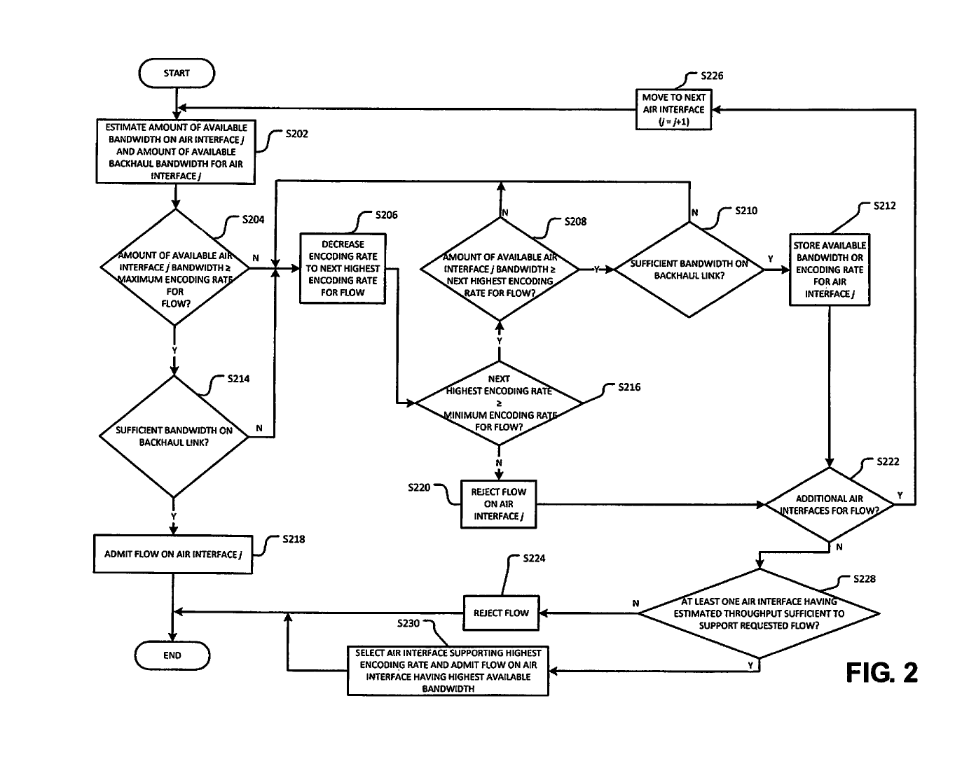

Still referring to FIG. 1, the CloudRAN server 106 further includes a call admission controller 1064. The call admission controller 1064 provides an additional call admission control mechanism to control admission of flows on available air interfaces by the MPTCP aggregation layer 1062. This additional call admission control may improve QoS/QoE for a given multimedia application for a UE. An example embodiment of the call admission controller 1064 and the call admission control mechanism will be discussed in more detail later with regard to FIG. 2.

Still referring to FIG. 1, the CloudRAN server 106 also includes eNB 1066, and is operatively connected to radio units 110_1, 110_2, 110_3, . . . , 110_J and WLAN AP (also referred to as standalone Wi-Fi) 108. The CloudRAN server 106 may be connected to the radio units 110_1, 110_2, 110_3, . . . , 110_J and the WLAN AP 108 via multiple transport connectivity options such as Ethernet/IP, optical fiber, wavelength division multiplexed optical networks, microwave, or the like.

The eNB 1066 represents at least a portion of (or all) eNB functionality as defined by the 3GPP depending on implementation. In one example, all functions of the eNB 1066 may be virtualized and run on the CloudRAN server 106. In another example, a portion of the eNB processing stack (e.g., non-time critical portions of the eNB processing for L3, PDCP, L2 packet processing, etc.) may be run on the CloudRAN server 106, whereas other functions may be delegated to the radio units 110_1, 110_2, 110_3, . . . , 110_J.

In a more specific example, the radio units 110_1, 110_2, 110_3, . . . , 110_J in a Centralized Radio Access Network (C-RAN) architecture include radio-frequency (RF) radios, but all or substantially all baseband processing (e.g., L1, L2, L3, OAM, Transport, etc.) is performed by the eNB 1066 at the CloudRAN server 106.

In a Split RAN architecture, however, the radio units 110_1, 110_2, 110_3, . . . , 110_J include RF radios and implement some eNB baseband processing (e.g., a portion of L1 processing, all of L1 processing and some L2 processing, etc.), whereas the remainder of the eNB baseband processing is implemented at the eNB 1066.

Still referring to FIG. 1, the radio units 110_1, 110_2, 110_3, . . . , 110J and the WLAN AP 108 may include one or more processors, various interfaces including one or more transmitters/receivers connected to one or more antennas, a computer readable medium, and (optionally) a display device. The one or more interfaces may be configured to transmit/receive (wireline and/or wirelessly) data to/from other network elements, such as the CloudRAN server 106, other radio units and WLAN APs and the UE 112.

In addition to other functions discussed herein, the radio units 110_1, 110_2, 110_3, . . . , 110_J at least provide wireless resources and radio coverage for UEs including UE 112. Thus, in the example shown in FIG. 1, the radio units 110_1, 110_2, 110_3, . . . , 110_J provide respective air interfaces AI_110_1, AI_110_2, AI_110_3, . . . , AI_110_J for the UE 112.

For the purpose of clarity, only one UE is illustrated in FIG. 1. However, any number of UEs may be connected to one or more of the radio units 110_1, 110_2, 110_3, . . . , 110_J.

The WLAN AP 108 provides WLAN (e.g., Wi-Fi) resources for client devices (e.g., UEs, such as UE 112) in range of, and attached to, the WLAN AP 108. The WLAN AP 108 allows wireless client devices (e.g., electronic devices having a WLAN transceiver) to connect to other (e.g., wireless and/or wired) networks, such as the Internet 100. The WLAN AP 108 provides an air interface AI_108. In the example shown in FIG. 1, the UE 112 may be attached to, and communicate with, the WLAN AP 108 and one or more of the radio units 110_1, 110_2, 110_3, . . . , 110_J via one or more of air interfaces AI_108 and AI_110_1, AI_110_2, AI_110_3, . . . , AI_110_J simultaneously or concurrently.

Example radio access technologies for the air interfaces AI_110_1, AI_1102, AI_110_3, . . . , AI_110_J include: multiple carriers for 4G Long-Term Evolution (LTE); time division duplexing (TDD) and frequency division duplexing (FDD); 5G radio bands; LTE TDD, which is a pre-emptable spectrum that supports the operation of the 28 GHz 5G mmW switched beam operation; LTE in unlicensed spectrum (LTE-U); License Assisted Access (LAA); MulTEfire; and 5G mmWave—trusted spectrum. An example radio access technology for air interface AI_108 is Wi-Fi.

For the sake of clarity, a given air interface among the plurality of air interfaces AI_110_1, AI_110_2, AI_110_3, . . . , AI_110_J and AI_108 is referred to by the index j; that is, a given air interface is referred to as a j-th air interface, a next air interface as (j+1)-th air interface, etc. Similarly, in some instances, a given flow may be referred to by the index i.

As discussed herein, a “user equipment” or “UE” refers to a remote user of wireless resources in a wireless communication network (e.g., 3GPP 3G, 4G, 5G networks) or WLAN. The term “user equipment” or “UE” may be considered synonymous to, and may hereafter be occasionally referred to, as user, client, client device, mobile unit, mobile station, mobile user, mobile, subscriber, user, remote station, access terminal, receiver, etc.

Example operation of the call admission controller 1064 and the CloudRAN server 106 will now be discussed in more detail with regard to FIG. 2.

FIG. 2 is a flow chart illustrating a method for call admission control for delivery of multimedia flows according to an example embodiment.

For example purposes, the method shown in FIG. 2 will be described with regard to the application server 101, CloudRAN server 106, the radio units 110_1, 110_2, 110_3, . . . , 110_J and UE 112 shown in FIG. 1. However, example embodiments should not be limited to this example.

According to at least some example embodiments, the CloudRAN server 106 has knowledge of the available air interfaces AI_110_1, AI_110_2, AI_110_3, . . . , AI_110_J and AI_108 (e.g., by virtue of MPTCP air interface discovery) for the UE 112. For a given multimedia flow for the UE 112, the CloudRAN server 106 parses through the available air interfaces one-by-one until (i) identifying an air interface that will support the maximum encoding rate to the UE 112 for the multimedia flow, or (ii) all available air interfaces have been considered.

If an air interface supporting the maximum encoding rate for the multimedia flow is identified, then the multimedia flow is admitted on that air interface. If, however, an air interface supporting the maximum encoding rate for the multimedia flow is not identified, once having considered all available air interfaces, the CloudRAN server 106 may select the air interface supporting the highest encoding rate for the multimedia flow from among the available air interfaces supporting at least the minimum encoding rate for the multimedia flow. If none of the air interfaces support the minimum encoding rate for the multimedia flow, then the flow is rejected by the CloudRAN server 106.

Referring now to FIG. 2, in response to receiving a multimedia flow from application server 101, at step S202 the call admission controller 1064 estimates an amount of available bandwidth on a j-th air interface and an amount of available bandwidth on the backhaul link associated with the j-th air interface. In one example, the call admission controller 1064 estimates the amount of available bandwidth on the j-th air interface based on a spectral bandwidth for the j-th air interface. Reserving a margin for other best effort (BE) flows, the call admission controller 1064 computes the difference between the available bandwidth and the encoding rates supported for current flows on the j-th air interface, and the computed difference is the estimated available bandwidth for the j-th air interface.

According to at least some example embodiments, the CloudRAN server 106 (e.g., by way of the eNB 1066) has a priori knowledge of the total provisioned bandwidth (e.g., Mbps) on a backhaul link for a given set of cells or sector-carriers. This backhaul bandwidth is operator dependent. As the eNB 1066 supports a given number of UEs in a sector, the eNB 1066 has knowledge of the backhaul bandwidth requirements for each of the applications for all the UEs currently being served based on the known relationship between the air interface data rate to each UE and its corresponding backhaul bandwidth. According to at least some example embodiments, the CloudRAN server 106 receives this updated backhaul bandwidth information every transmission time interval (TI), and determines an estimated amount of available bandwidth on the backhaul link to support either new UEs or a new application on an existing UE.

According to at least one example embodiment, the updated backhaul bandwidth information may be received in messages identifying radio access technology and their backhaul load either in terms of a data rate, a Percent Loading Factor or other loading/utilization metric.

As discussed herein, an amount of available bandwidth on a j-th air interface and an amount of available bandwidth on the backhaul link associated with the j-th air interface may be collectively referred to as throughput for the j-th interface. In other words, the throughput for the j-th interface may include an amount of available bandwidth on a j-th air interface and an amount of available bandwidth on the backhaul link associated with the j-th air interface

At step S204, the call admission controller 1064 determines whether the estimated amount of available bandwidth over the j-th air interface is greater than or equal to the maximum encoding rate for the multimedia flow. In one example, the call admission controller 1064 compares the estimated amount of available bandwidth over the j-th air interface with the maximum encoding rate for the multimedia flow.

According to at least one example embodiment, a particular application or given QoS may have an associated set of data rates. For example, a given QoS for a streaming video application may have a set of data rates between a minimum data rate of about 400 kbps and a maximum data rate of about 5 Mbps. Thus, an example maximum encoding rate for a given multimedia flow is 5 Mbps.

If the call admission controller 1064 determines that the estimated amount of available bandwidth over the j-th air interface is greater than or equal to the maximum encoding rate for the multimedia flow, then at step S214 the call admission controller 1064 determines whether there is sufficient bandwidth to support the maximum encoding rate for the multimedia flow on the backhaul link associated with the j-th air interface. In one example, the call admission controller 1064 determines that there is sufficient bandwidth to support the maximum encoding rate for the multimedia flow on the backhaul link if the amount of available bandwidth on the backhaul link is greater than or equal to that required to support the maximum encoding rate for the multimedia flow.

Still referring to FIG. 2, if the call admission controller 1064 determines that there is sufficient bandwidth to support the maximum encoding rate for the multimedia flow on the backhaul link associated with the j-th air interface, then at step S218 the CloudRAN server 106 admits the multimedia flow on the j-th air interface.

In at least one example embodiment, the CloudRAN server 106 (e.g., by way of the eNB 1066) may admit the multimedia flow by performing a standards defined procedure for initiating the call processing. For 3GPP-LTE, for example, the call process procedure is defined in 3GPP TR 23.802 v7.0.0. Different call processing procedures may be utilized depending on whether the accepted flow is for a new UE or a new application for an existing UE.

Returning to steps S204 and S214 in FIG. 2, if the call admission controller 1064 determines that the estimated amount of available bandwidth over the j-th air interface is less than the maximum encoding rate for the multimedia flow (step S204) or that there is not sufficient bandwidth to support the maximum encoding rate for the multimedia flow on the backhaul link associated with the j-th air interface (e.g., that the throughput for the j-th air interface is not sufficient), then at step S206 the call admission controller 1064 decreases the desired encoding rate for the multimedia flow to the next highest encoding rate in the set of encoding rates for the multimedia flow.

According to at least some example embodiments, the granularity of the set of encoding rates may depend on the application, and may be in the form of a linear or non-linear progression of data rates. In one example, the next highest encoding rate might be 100 kbps lower than the maximum encoding rate, so on.

If the next highest encoding rate for the multimedia flow is greater than or equal to (not less than) a minimum encoding rate for the multimedia flow (step S216), then at step S208 the call admission controller 1064 determines whether the estimated amount of available bandwidth over the j-th air interface (computed at step S202) is greater than or equal to the next highest encoding rate for the multimedia flow. The call admission controller 1064 determines whether the estimated amount of available bandwidth over the j-th air interface is greater than or equal to the next highest encoding rate for the multimedia flow in the same or substantially the same manner as discussed above with regard to step S204.

If the call admission controller 1064 determines that the estimated amount of available bandwidth over the j-th air interface is less than (not greater than or equal to) the next highest encoding rate for the multimedia flow at step S208, then the process returns to step S206 and continues as discussed herein.

Returning to step S208, if the call admission controller 1064 determines that the estimated amount of available bandwidth over the j-th air interface is greater than or equal to the next highest encoding rate for the multimedia flow, then at step S210 the call admission controller 1064 determines whether there is sufficient bandwidth to support the multimedia flow at the next highest encoding rate on the backhaul link associated with the j-th air interface. The call admission controller 1064 determines whether there is sufficient bandwidth to support the multimedia flow at the next highest encoding rate on the backhaul link associated with the j-th air interface in the same or substantially the same manner as discussed above with regard to step S214.

If the call admission controller 1064 determines that there is not sufficient bandwidth to support the multimedia flow at the next highest encoding rate on the backhaul link associated with the j-th air interface at step S210, then the process returns to step S206 and continues as discussed herein.

Returning to step S210, if the call admission controller 1064 determines that there is sufficient bandwidth to support the multimedia flow at the next highest encoding rate on the backhaul link associated with the j-th air interface, then at step S212 the call admission controller 1064 stores at least one of the available bandwidth or the supportable encoding rate for the j-th air interface along with an identifier for the j-th air interface in a memory, such as a buffer memory. In one example, this information may be stored in a table for the multimedia flow, an example of which is shown below in Table 1.

TABLE 1

| Air Interface | Encoding Rate | |
|---|---|---|
| j | 400 | kbps |
| j + 1 | 1 | Mbps |
| . | | |
| . | | |
| . | | |

At step S222, the call admission controller 1064 determines whether all available air interfaces known to the CloudRAN server 106 have been considered for the multimedia flow.

If all available air interfaces have not been considered, then the process moves to the next air interface (e.g., (j+1)-th air interface) at step S226, and returns to step S202. Another iteration of the process is then performed for the next air interface.

Returning to step S222, if the call admission controller 1064 determines that all available air interfaces have been considered, then the call admission controller 1064 determines whether at least one of the available air interfaces has an estimated throughput sufficient to support the multimedia flow at step S228. In the method shown in FIG. 2, the air interfaces having an estimated throughput sufficient to support the multimedia flow are stored in a memory at step S212. Accordingly, the call admission controller 1064 determines that there is at least one air interface having an estimated throughput with sufficient backhaul bandwidth to support the multimedia flow if an air interface identifier and estimated available bandwidth (or encoding rate) for the air interface are stored in the memory. The air interface(s) having an estimated throughput with sufficient backhaul bandwidth to support the multimedia flow may be referred to as a set or subset of air interfaces, which may include less than all of the available air interfaces.

If the call admission controller 1064 determines that at least one air interface has an estimated throughput sufficient to support the multimedia flow, then at step S230 the CloudRAN server 106 selects the air interface supporting the highest encoding rate for the multimedia flow (e.g., the air interface having the highest throughput including available bandwidth on the air interface and the backhaul link) from among the set of air interfaces, and admits the multimedia flow on the selected air interface. The CloudRAN server 106 admits the multimedia flow in the same or substantially the same manner as discussed above with regard to step S218.

Returning to step S228, if the call admission controller 1064 determines that none of the available air interfaces have an estimated throughput sufficient to support the multimedia flow (e.g., the estimated throughput for each of the available air interfaces is less than a minimum encoding rate for the multimedia flow), then at step S224 the CloudRAN server 106 rejects or denies the multimedia flow.

According to at least one example embodiment, the CloudRAN server 106 (e.g., by way of the eNB 1066) may reject or deny the multimedia flow by performing a standards defined procedure. In one example, if the application is network initiated, then the CloudRAN server 106 informs the Mobility Management Entity (MME) in the EPC that the multimedia flow has been rejected or denied, and the MME searches for another eNB that may admit the multimedia flow. If no other eNBs are found, then the MME informs the application server 101 that a call cannot be established.

Returning now to step S216 in FIG. 2, after decreasing the encoding rate for the multimedia flow to a next highest encoding rate (step S206), if the call admission controller 1064 determines that the next highest encoding rate for the multimedia flow is less than a minimum encoding rate for the multimedia flow, then at step S220 the CloudRAN server 106 rejects or denies the multimedia flow on the j-th air interface in the same or substantially the same manner as discussed above with regard to step S224. The process then proceeds to step S222 and continues as discussed herein.

The method shown in FIG. 2 may be performed periodically, and decisions reached by the call admission controller 1064 regarding whether a flow should be admitted on a given air interface may be stored in a table along with the identification for the flow and the encoding rate for the flow. An example table for a j-th air interface is shown below in Table 2.

TABLE 2

| Flow ID | Encoding Rate | Admit |
|---|---|---|
| i | 20 kbps | Y |
| i + 1 | 30 kbps | N |

According to at least some example embodiments, the MPTCP aggregation layer 1062 may access this table to determine whether to open a new TCP subflow before proceeding with the remaining functions required for MPTCP operation to help maintain sufficient QoS/QoE for a multimedia flow.

Although example embodiments are discussed herein with regard to MPTCP aggregation, example embodiments should not be limited to this example. Rather, example embodiments may be applied to other aggregation functions such as IP-in-IP encapsulation techniques or the like. In the case of IP-in-IP encapsulation, the IP-in-IP aggregation layer consults the call admission control algorithm through a table (e.g., Table 2) before deciding on whether to admit a call.

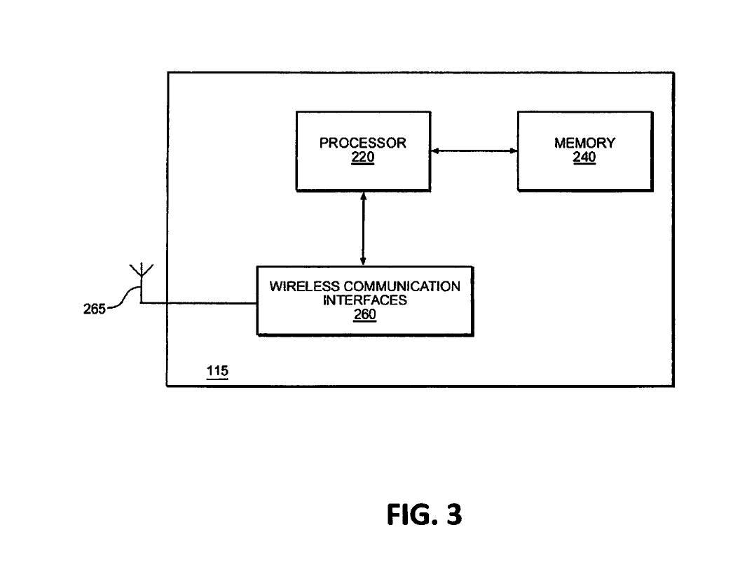

FIG. 3 depicts a high-level block diagram of a computer, computing or electronic device suitable for use in implementing, inter alia, the CloudRAN server 106, as well as other radio access and backhaul network elements and/or devices (e.g., SGWs, PGWs, application servers, WLAN APs, UEs, radio units, and the like).

Referring to FIG. 3, the CloudRAN server 106 includes: a memory 240; a processor 220 connected to the memory 240; various interfaces 260 connected to the processor 220; and an antenna 265 connected to the various interfaces 260. The various interfaces 260 and the antenna 265 may constitute a transceiver for transmitting/receiving data from/to other network elements. As will be appreciated, depending on the implementation of the CloudRAN server 106, the CloudRAN server 106 may include many more components than those shown in FIG. 3. However, it is not necessary that all of these components be shown in order to disclose the illustrative example embodiment.

The memory 240 may be a computer readable storage medium that generally includes a random access memory (RAM), read only memory (ROM), and/or a permanent mass storage device, such as a disk drive. The memory 240 also stores an operating system and any other routines/modules/applications for providing the functionalities of the CloudRAN server 106 (e.g., functionalities of a CloudRAN server, methods according to the example embodiments, etc.) to be executed by the processor 220. These software components may also be loaded from a separate computer readable storage medium into the memory 240 using a drive mechanism (not shown). Such separate computer readable storage medium may include a disc, tape, DVD/CD-ROM drive, memory card, or other like computer readable storage medium (not shown). In some example embodiments, software components may be loaded into the memory 240 via one of the various interfaces 260, rather than via a computer readable storage medium.

The processor 220 may be configured to carry out instructions of a computer program by performing the arithmetical, logical, and input/output operations of the system. Instructions may be provided to the processor 220 by the memory 240. The memory 240 may also store the information discussed above with regard to Tables 1 and 2.

The various interfaces 260 may include components that interface the processor 220 with the antenna 265, or other input/output components. As will be understood, the interfaces 260 and programs stored in the memory 240 to set forth the special purpose functionalities of the CloudRAN server 106 will vary depending on the implementation of the CloudRAN server 106.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the terms “or” and “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing users, user equipment, CloudRAN servers, gateways, base stations, radio units, eNBs, RRHs, gNBs, femto base stations, nodes, network controllers, computers, and the like. As discussed later, such existing hardware may include, inter alia, one or more Central Processing Units (CPUs), system-on-chip (SOC) devices, digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

The terms “including” and/or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, users, user equipments, radio units, gateways, base stations, CloudRAN servers, eNBs, RRHs, gNBs, femto base stations, nodes, network controllers, computers, and the like, may be (or include) hardware, firmware, hardware executing software or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs) computers or the like configured as special purpose machines to perform the functions described herein as well as any other well-known functions of these elements. In at least some cases, CPUs, SOCs, DSPs, ASICs and FPGAs may generally be referred to as processing circuits, processors and/or microprocessors.

While one or more example embodiments are described from the perspective of a CloudRAN server, MPTCP aggregation, call admission controller, or the like, it will be understood that one or more example embodiments discussed herein may be performed by the one or more processors (or processing circuitry) at the applicable apparatus or device.

Call admission control according to one or more example embodiments provides the ability to assign a given flow (e.g., a video or other multimedia flow) to an appropriate radio interface and associated backhaul link that will support the highest possible encoding rate for the given flow. Example embodiments discussed herein enable more informed call admission control decisions on a given channel and determines an appropriate encoding level for an incoming flow on the channel (band).

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

Reference is made in detail to embodiments, examples of which are illustrated in the accompanying drawings, wherein like reference numerals refer to the like elements throughout. In this regard, the example embodiments may have different forms and should not be construed as being limited to the descriptions set forth herein. Accordingly, the example embodiments are merely described below, by referring to the figures, to explain example embodiments of the present description. Aspects of various embodiments are specified in the claims.

What is claimed is:

1. A radio access network element comprising:
a memory storing computer-readable instructions; and
at least one processor coupled to the memory, the at least one processor configured to execute the computer-readable instructions to
estimate, for a multimedia flow for a user equipment, an amount of available bandwidth on a first of a plurality of different air interfaces and an amount of available bandwidth on a first backhaul link associated with the first of the plurality of different air interfaces, and
admit the multimedia flow on the first of the plurality of different air interfaces if the amount of available bandwidth on the first of the plurality of different air interfaces and the amount of available bandwidth on the first backhaul link are greater than or equal to a maximum encoding rate for the multimedia flow.

2. The radio access network element of claim 1, wherein the at least one processor is further configured to execute the computer-readable instructions to
reject the multimedia flow on the first of the plurality of different air interfaces if the amount of available bandwidth on the first of the plurality of different air interfaces is less than a minimum encoding rate for the multimedia flow.

3. The radio access network element of claim 1, wherein the at least one processor is further configured to execute the computer-readable instructions to
estimate the amount of available bandwidth on the first of the plurality of different air interfaces based on a spectral bandwidth for the first of the plurality of different air interfaces.

4. The radio access network element of claim 1, wherein the plurality of different air interfaces operate across both licensed and unlicensed spectra.

5. The radio access network element of claim 1, wherein the multimedia flow is a Multipath Transmission Control Protocol (MPTCP) flow.

6. The radio access network element of claim 1, wherein the at least one processor is further configured to execute the computer-readable instructions to
create a plurality of MPTCP flows based on a TCP flow terminating at the radio access network element, the multimedia flow being a MPTCP flow among the plurality of MPTCP flows.

7. A radio access network element comprising:
a memory storing computer-readable instructions; and
at least one processor coupled to the memory, the at least one processor configured to execute the computer-readable instructions to
estimate, for a multimedia flow for a user equipment, a throughput for each of a plurality of different air interfaces, the throughput for a respective air interface among the plurality of different air interfaces including (i) an amount of available bandwidth on the respective air interface and (ii) an amount of available bandwidth on a backhaul link associated with the respective air interface,
select an air interface from among the plurality of different air interfaces based on the throughput for each of the plurality of different air interfaces, and
admit the multimedia flow on the selected air interface.

8. The radio access network element of claim 7, wherein the selected air interface is an air interface from among the plurality of different air interfaces having a highest throughput.

9. The radio access network element of claim 7, wherein the at least one processor is further configured to execute the computer-readable instructions to
reject the multimedia flow if the throughput for each of the plurality of different air interfaces is less than a minimum encoding rate for the multimedia flow.

10. The radio access network element of claim 7, wherein the at least one processor is further configured to execute the computer-readable instructions to
estimate the amount of available bandwidth on the respective air interface based on a spectral bandwidth for the respective air interface.

11. The radio access network element of claim 7, wherein the plurality of different air interfaces operate across both licensed and unlicensed spectra.

12. The radio access network element of claim 7, wherein the multimedia flow is a MPTCP flow.

13. The radio access network element of claim 7, wherein the at least one processor is further configured to execute the computer-readable instructions to
create a plurality of MPTCP flows based on a TCP flow terminating at the radio access network element, the multimedia flow being a MPTCP flow among the plurality of MPTCP flows.

14. The radio access network element of claim 7, wherein the at least one processor is further configured to execute the computer-readable instructions to
identify a set of the plurality of different air interfaces having a throughput greater than or equal to a minimum encoding rate for the multimedia flow, and
select the air interface from among the set of the plurality of different air interfaces.

15. A method for call admission control in a multi-connectivity network, the method comprising:
estimating, for a multimedia flow for a user equipment, a throughput for each of a plurality of different air interfaces, the throughput for a respective air interface among the plurality of different air interfaces including (i) an amount of available bandwidth on the respective air interface and (ii) an amount of available bandwidth on a backhaul link associated with the respective air interface;
selecting an air interface from among the plurality of different air interfaces based on the throughput for each of the plurality of different air interfaces; and
admitting the multimedia flow on the selected air interface.

16. The method of claim 15, wherein the selected air interface is an air interface from among the plurality of different air interfaces having a highest throughput.

17. The method of claim 15, further comprising:
rejecting the multimedia flow if the throughput for each of the plurality of different air interfaces is less than a minimum encoding rate for the multimedia flow.

18. The method of claim 15, wherein the estimating estimates the amount of available bandwidth on the respective air interface based on a spectral bandwidth for the respective air interface.

19. The method of claim 15, wherein the plurality of different air interfaces operate across both licensed and unlicensed spectra.

20. The method of claim 15, further comprising:
identifying a set of the plurality of different air interfaces having throughput greater than or equal to a minimum encoding rate for the multimedia flow; and wherein
the selecting selects the air interface from among the set of the plurality of different air interfaces.
